(19) United States
(12) Patent Application Publication
(10) Pub. No.: US 2019/0004665 A1
(43) Pub. Date: Jan. 3, 2019

(54) APPARATUS AND METHOD FOR ALTERING A USER INTERFACE BASED ON USER INPUT ERRORS

(71) Applicant: THOMSON Licensing, Issy-les-Moulineaux (FR)

(72) Inventors: Hans WEE, Culver City, CA (US); Aditi PANDYA, Culver City, CA (US)

(21) Appl. No.: 16/066,361

(22) PCT Filed: Dec. 28, 2015
(86) PCT No.: PCT/US2015/067729

§ 371 Date: Jun. 27, 2018

(51) Int. Cl. G06F 3/041; G06F 3/0488; G06F 3/16

(52) U.S. Cl. CPC G06F 3/0418; G06F 3/167; G06F 3/04886

(57) ABSTRACT

The present principles generally relate to user interaction processing by a device, and particularly, to apparatuses and methods for altering a user interface of a device based on user input errors of a user of the device. In an exemplary embodiment, a device having a user interface determines what functions a user is trying to operate and see if the person is using it correctly. Accordingly, the exemplary device keeps track of the number and/or the types of errors that a user is making during the use of the user interface. The device will alter the user interface to one of a number of altered formats based on the number and/or types of errors that a user is making.

### BACKGROUND

### Field of the Invention

The present principles generally relate to user interaction processing by a device, and particularly, to apparatuses and methods for altering a user interface of a device based on user input errors of a user of the device.

### Background Information

Various multimedia and/or mobiles devices such as cell phones and tablets are available to the consumers today. They are typically controlled by using a user interface displayed on a touch screen of the device. The functions and features of the devices are usually controlled based on a user providing user inputs via the user interface of the device. For example, a user may play a multimedia content by touching a virtual “play” key on the screen, or dial a phone number or type a text string by using a virtual numeric keyboard on the user interface of the device.

### SUMMARY

Therefore, an apparatus is presented, comprising: a display configured to display a user interface; a user input device configured to receive a plurality of user inputs from a user; and a processor configured to determine one or more errors associated with use of the user interface by the user based on the received plurality of user inputs, and alter the user interface to one of a plurality of formats based on the determined one or more errors.

In another exemplary embodiment, a method performed by an apparatus is presented, comprising: providing a user interface on a display; receiving a plurality of user inputs from a user via a user input device; and determining one or more errors associated with use of the user interface by the user based on the received plurality of user inputs, and altering the user interface to one of a plurality of formats based on the determined one or more errors.

In another exemplary embodiment, a computer program product stored in a non-transitory computer-readable storage medium is presented, comprising computer-executable instructions when executed on a processor causes the computer to: providing a user interface on a display; receiving a plurality of user inputs from a user via a user input device; and determining one or more errors associated with use of the user interface by the user based on the received plurality of user inputs, and altering the user interface to one of a plurality of formats based on the determined one or more errors.

### DETAILED DESCRIPTION OF THE DRAWINGS

The above-mentioned and other features and advantages of the present principles, and the manner of attaining them, will become more apparent and the present invention will be better understood by reference to the following description of embodiments of the present principles taken in conjunction with the accompanying drawings, wherein:

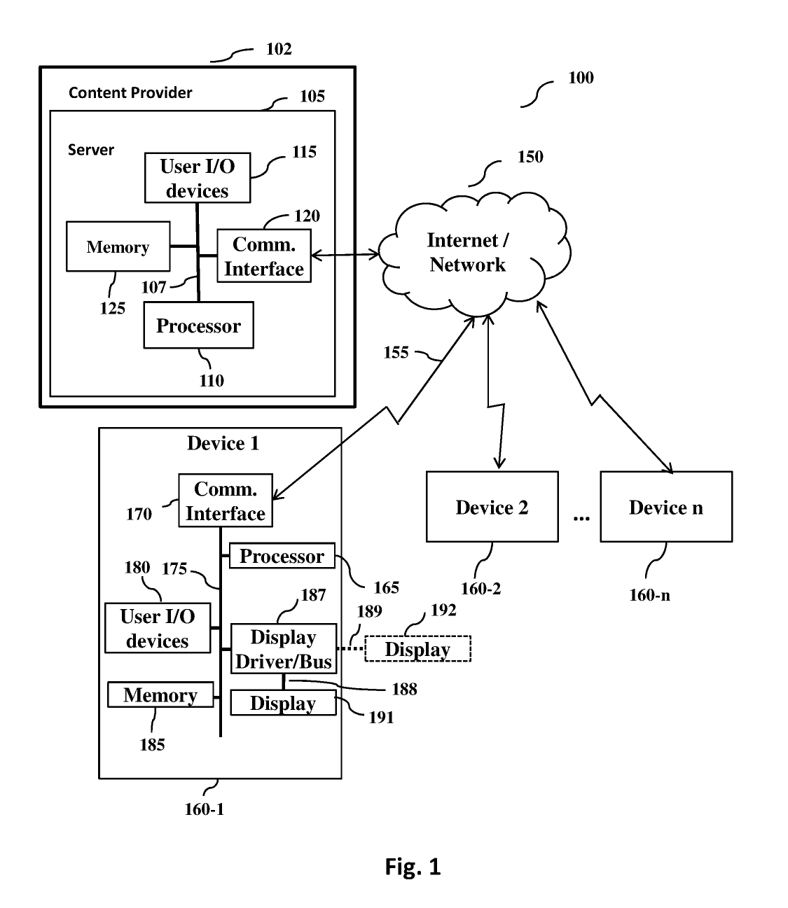

FIG. 1 shows an exemplary system according to the present principles;

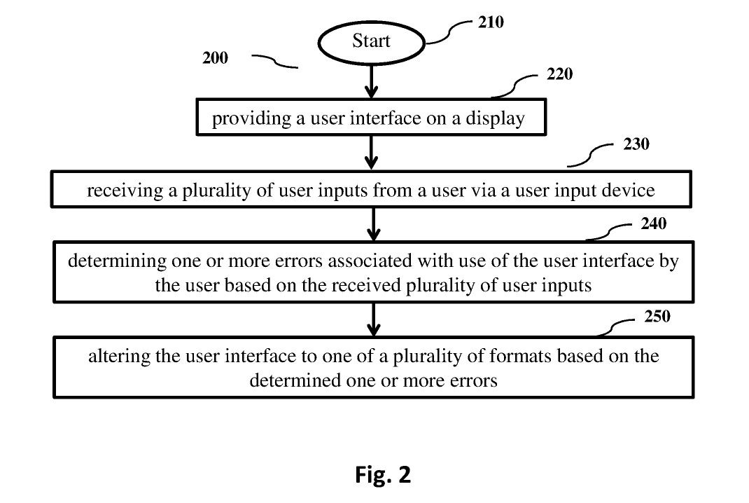

FIG. 2 shows an exemplary process according to the present principles;

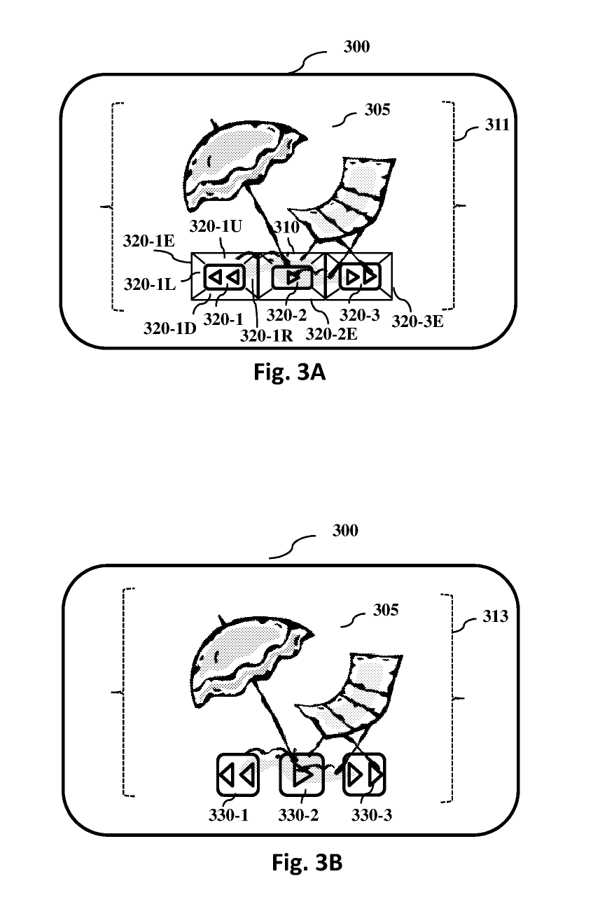

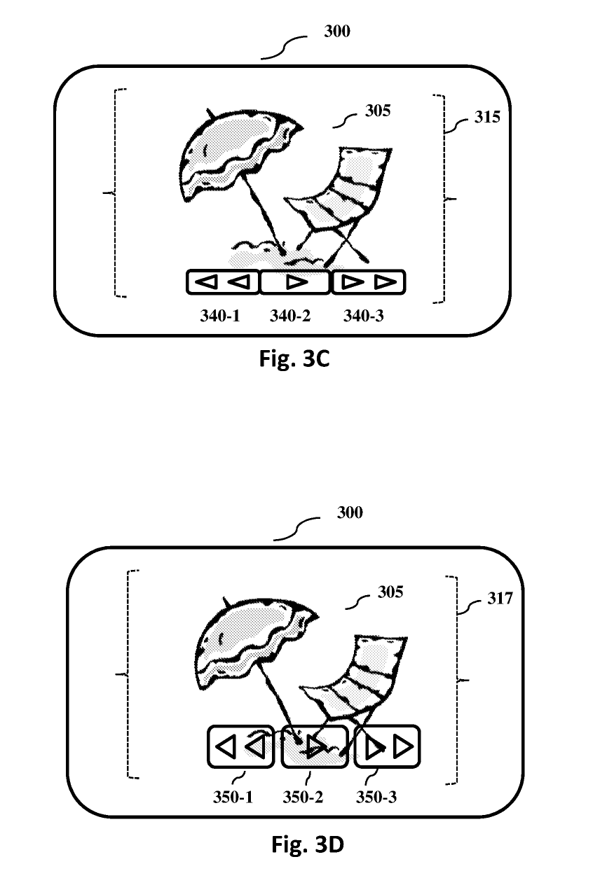

FIGS. 3A-3D show exemplary user interfaces according to the present principles; and

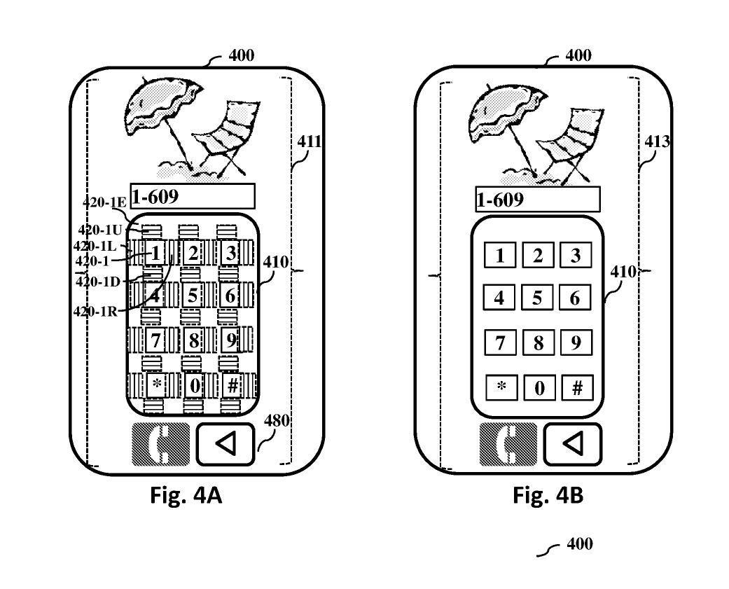

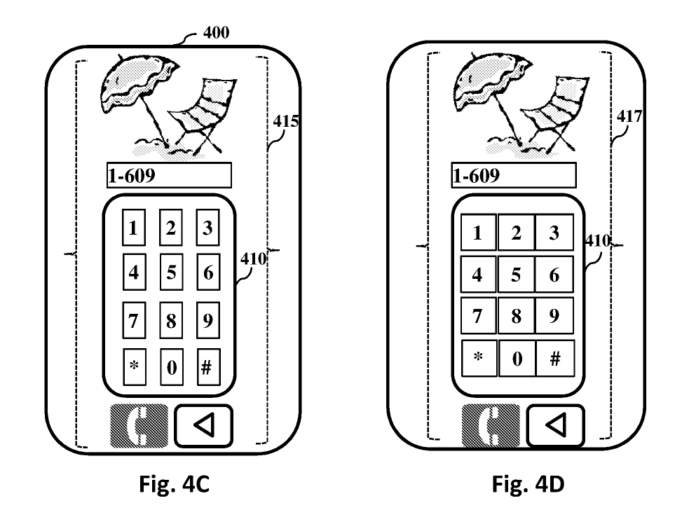

FIGS. 4A-4D show other exemplary user interfaces according to the present principles.

The examples set out herein illustrate exemplary embodiments of the present principles. Such examples are not to be construed as limiting the scope of the present principles in any manner.

### DETAILED DESCRIPTION

The present principles recognize that there is a concern about how people such as senior citizens use new technology such as smart phones and/or other multimedia devices. For example, with the number of icons, menu selections and/or applications on a cell phone, it may be difficult for a person such as a senior citizen to use such a device because the user interface may be hard to read, hard to control because of the size of the virtual buttons that are part of the user interface, or may contain too many functions that are confusing for the senior.

Therefore, the present principles provide a device having a user interface that is capable of determining what functions a user is trying to operate and see if the user is using such a function correctly. Accordingly, an exemplary device keeps track of the number and/or the types of errors that a user is making during the use of the user interface. The device will alter the user interface to one of a number of altered formats based on the number and/or types of errors that a user is making. In one exemplary embodiment, the altered user interface formats are selected by a remote user such as a son/daughter of a senior citizen user. In another embodiment, a voice recognition based user interface will automatically be used as the altered format. In another embodiment, the alternative user interface formats may be downloaded from the Internet.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventors to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment”, “an embodiment”, “an exemplary embodiment” of the present principles, or as well as other variations thereof, means that a particular feature, structure, characteristic, and so forth described in connection with the embodiment is included in at least one embodiment of the present principles. Thus, the appearances of the phrase “in one embodiment”, “in an embodiment”, “in an exemplary embodiment”, or as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option

(A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

FIG. 1 shows an exemplary system 100 according to the present principles. The exemplary system 100 in FIG. 1 includes a content provider 102 which is capable of receiving and processing user requests from one or more of user devices 160-1 to 160-n. The content provider 102, in response to the user requests, provides program contents comprising various multimedia programs such as movies or TV shows for viewing, streaming or downloading by users using the devices 160-1 to 160-n.

Various exemplary user devices 160-1 to 160-n in FIG. 1 may communicate with an exemplary server 105 of the content provider 102 over a communication network 150 such as the Internet, a wide area network (WAN), and/or a local area network (LAN). Content server 105 may communicate with user devices 160-1 to 160-n in order to provide and/or receive relevant information such as, e.g., viewer profile data, user editing selections, content metadata, recommendations, user ratings, web pages, media contents, and etc., to and/or from the user devices 160-1 to 160-n thru the network connections. Server 105 may also provide additional processing of information and data when the processing is not available and/or capable of being conducted on the local user devices 160-1 to 160-n. As an example, server 105 may be a computer having a processor 110 such as, e.g., an Intel processor, running an appropriate operating system such as, e.g., Windows 2008 R2, Windows Server 2012 R2, Linux operating system, and etc.

User devices 160-1 to 160-n shown in FIG. 1 may be one or more of, e.g., a computer, a laptop, a tablet, a cellphone, smartphone, a video receiver, a portable device with a display, and the like. Examples of such devices may be, e.g., a Microsoft Windows 10 computer/tablet, an Android phone/tablet, an Apple zo IOS phone/tablet, a digital television receiver, or the like. A detailed block diagram of an exemplary user device according to the present principles is illustrated in block 160-1 of FIG. 1 as Device 1 and will be further described below.

An exemplary user device 160-1 in FIG. 1 comprises a processor 165 for processing various data and for controlling various functions and components of the device 160-1. The processor 165 communicates with and controls the various functions and components of the device 160-1 via a control bus 175 as shown in FIG. 1. For example, the processor 165 provides video encoding, decoding, transcoding and data formatting capabilities in order to play, display, and/or transport the video content. In addition, processor 165 also provides the processing including the formatting and alterations of the various user interfaces as shown in FIGS. 3A-3D and FIGS. 4A-4D, as to be described further below.

Device 160-1 may also comprise a display 191 which is driven by a display driver/bus component 187 under the control of processor 165 via a display bus 188 as shown in FIG. 1. The display 191 may be a touch display in accordance with the present principles. In addition, the type of the display 191 may be, e.g., LCD (Liquid Crystal Display), LED (Light Emitting Diode), OLED (Organic Light Emitting Diode), and etc. In addition, an exemplary user device 160-1 according to the present principles may have its display outside of the user device, or that an additional or a different external display may be used to display the content provided by the display driver/bus component 187. This is illustrated, e.g., by an external display 192 which is connected to an external display connection 189 of device 160-1 of FIG. 1.

In additional, exemplary device 160-1 in FIG. 1 may also comprise various user input/output (I/O) devices 180. The user interface devices 180 of the exemplary device 160-1 may represent e.g., a mouse, touch screen capabilities of a display (e.g., display 191 and/or 192), a touch and/or a physical keyboard of an user interface for inputting user data, as illustrated in FIGS. 3A-3D and FIGS. 4A-4D, as to be described further below. The user interface devices 180 of the exemplary device 160-1 may also comprise a speaker or speakers, and/or other zo indicator devices, for outputting visual and/or audio sound, user data and feedback.

Exemplary device 160-1 also comprises a memory 185 which may represent both a transitory memory such as RAM, and a non-transitory memory such as a ROM, a hard drive, a CD drive, a Blu-ray drive, and/or a flash memory, for processing and storing different files and information as necessary, including computer program products and software (e.g., as represented by a flow chart diagram of FIG. 2, as to be discussed below), webpages, user interface information, various databases, and etc., as needed. In addition, device 160-1 also comprises a communication interface 170 for connecting and communicating to/from server 105 and/or other devices, via, e.g., the network 150 using a link 155 representing, e.g., a connection through a cable network, a FIOS network, a Wi-Fi network, and/or a cellphone network (e.g., 3G, 4G, LTE, 5G), and etc.

According to the present principles, user devices 160-1 to 160-n in FIG. 1 may access, if applicable, different media programs, user interface screens, web pages, services or databases provided by server 105 using, e.g., HTTP protocol. A well-known web server software application which may be run by server 105 to provide web pages is Apache HTTP Server software available from http://www.apache.org. Likewise, examples of well-known media server software applications include Adobe Media Server and Apple HTTP Live Streaming (HLS) Server. Using media server software as mentioned above and/or other open or proprietary server software, server 105 may provide media content services similar to, e.g., Amazon.com, Netflix, or M-GO. Server 105 may use a streaming protocol such as e.g., Apple HTTP Live Streaming (HLS) protocol, Adobe Real-Time Messaging Protocol (RTMP), Microsoft Silverlight Smooth Streaming Transport Protocol, and etc., to transmit various programs comprising various multimedia assets such as, e.g., movies, TV shows, software, games, electronic books, electronic magazines, and etc., to an end-user device 160-1 for purchase and/or viewing via streaming, downloading, receiving or the like.

Turning to further detail of the web and content server 105 of FIG. 1, the server 105 may comprise a processor 110 which controls the various functions and components of the server 105 via a control bus 107 as shown in FIG. 1. In addition, a server administrator may interact with and configure server 105 to run different applications using different user input/output (I/O) devices 115 (e.g., a keyboard and/or a display) as well known in the art. Server 105 also comprises a memory 125 which may represent both a transitory memory such as RAM, and a non-transitory memory such as a ROM, a hard drive, a CD drive, a Blu-ray drive, and/or a flash memory, for processing and storing different files and information as necessary, including computer program products and software (e.g., as represented by a flow chart diagram of FIG. 2, as to be discussed below), webpages, user interface information, user profiles, metadata, electronic program listing information, databases, search engine software, and etc., as needed. A search engine may be stored in the non-transitory memory 125 of sever 105 as necessary, so that media recommendations may be made, e.g., in response to a user's profile of disinterest and/or interest in certain media assets, and/or criteria that a user specifies using textual input (e.g., queries using “sports”, “adventure”, “Tom Cruise”, and etc.), or based on ratings of the available multimedia programs.

In addition, server 105 is connected to network 150 through a communication interface 120 for communicating with other servers or web sites (not shown) and one or more user devices 160-1 to 160-n, as shown in FIG. 1. The communication interface 120 may also represent television signal modulator and RF transmitter in the case when the content provider 102 represents a terrestrial television station, or a cable or satellite television provider. In addition, one skilled in the art would readily appreciate that other well-known server components, such as, e.g., power supplies, cooling fans, etc., may also be needed, but are not shown in FIG. 1 to simplify the drawing.

FIG. 2 represents a flow chart diagram of an exemplary process 200 according to the present principles. The exemplary process 200 may be implemented as a computer program product comprising computer executable instructions which may be executed by a processor (e.g., processor 110 of sever 105 and/or processor 165 of device 160-1 of FIG. 1). The computer program product having the computer-executable instructions may be stored in a non-transitory computer-readable storage medium as represented by e.g., memory 125 of server 105 and/or memory 185 of device 160-1 of FIG. 1, as described above, a portable memory such as a Thumb Drive, and the like. One skilled in the art can readily recognize that the exemplary process 200 may also be implemented using a combination of hardware and software (e.g., a firmware implementation), and/or executed using programmable logic arrays (PLA) or application-specific integrated circuit (ASIC), etc., as already mentioned above.

The exemplary process 200 in FIG. 2 starts at step 210. At step 220, a user interface of a device is provided on a display of the device. This is illustrated, e.g., in FIG. 3A. FIG. 3A shows an exemplary user interface 311 (i.e., as indicated by the bracket 311) for a device such e.g., device 160-1 of FIG. 1 is provided on a display screen 300 of the device's display such as e.g., display 191 and/or 192 of FIG. 1.

At step 230 of FIG. 2, a plurality of user inputs, inputted through a user input device represented by, e.g., a user I/O device 180 of FIG. 1, are received by the user device 160-1 of FIG. 1. At step 240 of FIG. 2, if applicable, one or more errors made by the user associated with the use of the user interface are determined based on the received plurality of user inputs, in relationship to the user interface 311 of FIG. 3A being displayed to the user. At step 250 of FIG. 2, the user interface 311 shown in, e.g., FIG. 3A will be altered to one of a plurality of formats 313, 315 and 317, as shown respectively in FIGS. 3B to 3D, based on the determined one or more errors, to be described further below.

For example, FIG. 3A illustrates an example when a user of a device 160-1 is watching video content 305 on a display screen 300. The user interface 311 comprises an exemplary touch key pad 310 which has a plurality of three touch sensitive keys 320-1 to 320-3. As is well known in the art, when interacting with a video 305, a user may use a play key 320-2 to play the video content, a rewind key 320-1 to rewind the content, or a fast forward key 320-3 to fast forward the content 305.

Since the screen size of a mobile device such as a mobile phone is zo typically small (e.g., a 6-inch screen or smaller), the present principles recognize that it is advantageous for a user interface to present these interactive keys to be as small as feasible so that they will not obstruct the view of the video content 305, when the keys 320-1 to 320-3 appear on the screen 300 at the same time as the video 305, as shown in FIG. 3A. In accordance with the present principles, a user of the device may have difficulty pressing the correct key corresponding to his or her intended interaction with the video content 305 and therefore key pressing errors of the user may occur.

Accordingly, the present principles detect potential user interaction errors by detecting e.g., when a user's touch has missed the area of a corresponding key. To detect the one or more potential errors of the user, each key has a corresponding error detection area defined which surrounds the area of the defined key. For example, the rewind key 320-1 in FIG. 3A has a corresponding error detection area 320-1E, surrounding the area defining the rewind key 320-1. The error detection area 320-1E may be further divided into 4 quadrants as shown in FIG. 3A: a left quadrant 320-1L, a right quadrant 320-1R, an upper quadrant 320-1L, and a down quadrant 320-1D. The purpose of these quadrants will be further described below.

In accordance with an exemplary embodiment of the present principles, if the user device 160-1 of FIG. 1 detects that e.g., a user has consistently missed one of the keys 320-1 to 320-3 and instead has touched one of the error detection areas 320-1E to 320-3E as shown in FIG. 3A, the device 160-1 will therefore automatically alter the user interface 311 shown in FIG. 3A to one of a plurality of alternate formats as shown in FIG. 3B-FIG. 3D.

For example, in one exemplary embodiment according to the present principles as shown in FIG. 3D, upon detecting that the user has made more than a threshold number (e.g., threshold number may be 1 to 5) of touch key errors by touching one of the error detection areas 320-1E to 320-3E, the icons of the respective keys 350-1 to 350-3 will be enlarged, as shown in an exemplary user interface 317 FIG. 3D.

In other embodiments, the altered format of the user interface 311 in FIG. 3A, such as e.g., the direction of the key enlargement will depend on the type of the user interaction error being made and detected. For example, if a user consistently touches either an upper quadrant (e.g., 320-1U of the rewind key 320-1) or down quadrant (e.g., 320-1D of the rewind key 320-1) of any of the keys 320-1 to 320-3 in FIG. 3A more than a threshold number of times in error, then the keys 320-1 to 320-3 in FIG. 3A will be enlarged in the direction of the errors. In this case, the keys 320-1 to 320-3 will be enlarged in the vertical direction as shown in FIG. 3B. In another exemplary embodiment, if a user consistently touches either a left quadrant (e.g., 320-1L of the rewind key 320-1) or a right quadrant (e.g., 320-1R of the rewind key 320-1) of any of the keys 320-1 to 320-3 in FIG. 3A more than a threshold number of times in error, then the keys 320-1 to 320-3 in FIG. 3A will be enlarged in the horizontal direction as shown in FIG. 3C. In other embodiments, the enlargement of the keys will only be in the direction of the specific quadrant in which the user has made the touch errors more than a threshold number of times. The exemplary embodiments may include altering the shape of the icon representing the keys such as e.g., from a square shape to a circle, or vice versa, and etc.

FIG. 4A to FIG. 4D show other exemplary user interfaces for a phone dialing application of an exemplary user device 160-1 shown in FIG. 1, according to the present principles. Similar to what has already been described in connection with FIG. 3A to FIG. 3D previously, each of the surrounding areas surrounding a respective key in the keypad 410 of an exemplary user interface 411 shown in FIG. 4A has respectively an error detection area (as represented by areas in dash-line fills as shown in FIG. 4A). Each of the error detection area surrounding a key on keypad 410 has also been divided into four quadrants. For example, the “1” key 420-1 in keypad 410 shown in FIG. 4A has a left quadrant 420-1L, a right quadrant 420-1R, an upper quadrant 420-1U, and a down quadrant 420-1D.

In accordance with an exemplary embodiment of the present principles, if the user device 160-1 of FIG. 1 detects that e.g., a user has consistently missed one of the key in keypad 410 and instead has touched one of the error detection areas as shown in FIG. 4A, the device 160-1 will therefore automatically alter the user interface 411 shown in FIG. 4A to one of a plurality of alternate formats as shown in FIG. 4B-FIG. 4D. For example, in one exemplary embodiment according to the present principles, upon detecting that the user has made more than a threshold number (e.g., threshold number may be 1 to 5) of touch key errors by touching one of the error detection areas in keypad 410 as shown in FIG. 4A, the respective keys in keypad 410 will be enlarged, as shown in an exemplary altered user interface format 417 in FIG. 4D.

In other embodiments, the altered format of the user interface 411 in FIG. 4A, such as the direction of the key enlargement will depend on the type of the user interaction error or errors being made. For example, if a user consistently touches either an upper quadrant (e.g., 420-1U) or down quadrant (e.g., 420-D) of any of the keys in keypad 410 of FIG. 4A more than a threshold number of times in error, then the keys in keypad 410 of FIG. 3A will be enlarged in the direction of the errors, e.g., in this case, in the vertical direction as shown in FIG. 4C. In another exemplary embodiment, if a user consistently touches either a left quadrant (e.g., 420-1L) or right quadrant (e.g., 420-1R) of any of the keys in keypad 410 of FIG. 4A more than a threshold number of times in error, then the keys in keypad 410 shown in FIG. 4A will be enlarged in the horizontal direction as shown in FIG. 4B. The exemplary embodiments may include altering the shape representing the keys e.g., from a square shape to a circle, or vice versa, and etc. In other embodiments, the enlargement of the keys will be only in the direction of the specific quadrant in which the user has made the touch errors more than a threshold number of times.

In another exemplary embodiment according to the present principles, the types of error detected may be determined based on e.g., the types of keys used by a user. For example, if the device 160-1 detects that a user has pressed a delete key such as key 480 shown in FIG. 4A a number of times exceeding a threshold number (e.g., threshold number may be 1 to 5), the exemplary user interface will automatically alter the user interface 411 to one of a plurality of altered formats. In one non-limiting example, the user interface 411 may be altered to automatically be configured to accept voice based commands. zo Features and applications incorporating voice based commands are readily available in today's mobile devices. Some of the well-known examples include Apple Siri and Google Voice.

In another exemplary embodiment, the altered user interface formats are pre- selected by a remote user such as a son/daughter of the senior user. For example, an exemplary device 160-1 shown in FIG. 1 may allow another user, e.g., a user of any of the devices 160-2 to 160-n to remotely access the device 160-1 in order to configure the sequence of available altered user interface formats depending on the type or the number of errors made from the use of the user interface on device 160-1. In another embodiment, the remote user may remotely specify the threshold number of errors to be made before an alternative user interface is shown to the user. Therefore, a son or a daughter (as an example of another person) of a senior citizen using the exemplary device 160-1 may configure the settings of the user interface on device 160-1 to best suit the senior citizen's needs. In another embodiment, the various alternative user interface formats may be downloaded from the content provider 102, or some other websites via the Internet 150 as shown in FIG. 1. Likewise, other forced modification of a user interface to accommodate the needs of different users can be performed in accordance with the exemplary principles.

While several embodiments have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present embodiments. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings herein is/are used. Those skilled in the art will recognize, or be able to ascertain using no more than routine experimentation, many equivalents to the specific embodiments described herein. It is, therefore, to be understood that the foregoing embodiments are presented by way of example zo only and that, within the scope of the appended claims and equivalents thereof, the embodiments disclosed may be practiced otherwise than as specifically described and claimed. The present embodiments are directed to each individual feature, system, article, material and/or method described herein. In addition, any combination of two or more such features, systems, articles, materials and/or methods, if such features, systems, articles, materials and/or methods are not mutually inconsistent, is included within the scope of the present embodiment.

1. An apparatus, comprising:
a display configured to display a user interface;
a user input device configured to receive a plurality of user inputs from a user; and
a processor configured to determine at least one error associated with use of the user interface by the user based on the received plurality of user inputs, and alter the user interface to one of a plurality of formats based on the determined at least one error.

2. The apparatus of claim 1 wherein the user interface is altered based on a determined number of the determined at least one error exceeding a threshold number.

3. The apparatus of claim 2 wherein the user interface is additionally altered also based on a type or types of the determined at least one error.

4. The apparatus of claim 1 wherein the altered user interface format is pre-selected by a remote user.

5. The apparatus of claim 1 wherein the display is a touch display and the user interface is a virtual keypad.

6. The apparatus of claim 5 wherein the virtual key pad is altered by enlarging the virtual keypad.

7. The apparatus of claim 6 wherein the virtual key pad is enlarged in the horizontal direction.

8. The apparatus of claim 6 wherein the virtual key pad is enlarged in the vertical direction.

9. The apparatus of claim 1 wherein the apparatus is a device selected from a group comprising: a computer, a laptop, a tablet, a cellphone, smartphone, a video receiver, a portable device with a display.

10. The apparatus of claim 1 wherein the altered user interface is configured to accept voice based commands

11. A method performed by an apparatus, comprising:
providing a user interface on a display;
receiving a plurality of user inputs from a user via a user input device; and
determining at least one error associated with use of the user interface by the user based on the received plurality of user inputs, and
altering the user interface to one of a plurality of formats based on the determined at least one error.

12. The method of claim 11 wherein the altering is altered based on a determined number of the at least one error exceeds a threshold number.

13. The method of claim 12 wherein the altering is also based on a type or types of the determined at least one error.

14. The method of claim 11 wherein the altered user interface format is pre-selected by a remote user.

15. The method of claim 11 wherein the display is a touch display and the user interface is a virtual keypad.

16. The method of claim 15 wherein the virtual key pad is altered by enlarging the virtual keypad.

17. The method of claim 16 wherein the virtual key pad is enlarged in the horizontal direction.

18. The method of claim 16 wherein the virtual key pad is enlarged in the vertical direction.

19. The method of claim 11 wherein the apparatus is a device selected from a group comprising: a computer, a laptop, a tablet, a cellphone, smartphone, a video receiver, a portable device with a display.

20. The method of claim 11 wherein the altered user interface is configured to accept voice based commands.

21. A computer program product stored in a non-transitory computer-readable storage medium, comprising computer-executable instructions for:
providing a user interface on a display;
receiving a plurality of user inputs from a user via a user input device; and
determining at least one error associated with use of the user interface by the user based on the received plurality of user inputs, and
altering the user interface to one of a plurality of formats based on the determined at least one error.
